(19) United States
(12) Patent Application Publication
(10) Pub. No.: US 2021/0168743 A1
(43) Pub. Date: Jun. 3, 2021

(54) Base Station Coordinated Synchronization Block Transmissions in Integrated Access and Backhaul Network

(71) Applicant: SHARP KABUSHIKI KAISHA, Sakai City, Osaka (JP)

(72) Inventors: JIA SHENG, Vancouver, WA (US); TATSUSHI AIBA, Sakai City, Osaka (JP); KAZUNARI YOKOMAKURA, Sakai City, Osaka (JP)

(21) Appl. No.: 17/262,996

(22) PCT Filed: Aug. 8, 2019
(86) PCT No.: PCT/JP2019/031398

§ 371 Date: Jan. 25, 2021

Related U.S. Application Data
(60) Provisional application No. 62/716,897, filed on Aug. 9, 2018.

(51) Int. Cl. H04W 56/00; H04W 72/00; H04W 88/14; H04L 1/16; H04W 24/10

(52) U.S. Cl. CPC H04W 56/001; H04W 72/005; H04W 24/10; H04L 1/1614; H04W 88/14

(57) ABSTRACT

An Integrated Access and Backhaul (IAB) node that communicates over a radio interface, the IAB node comprising: receiving circuity configured to receive first bitmap information used for indicating which synchronization signal and physical broadcast channel block (SS/PBCH block) is transmitted in a SS/PBCH block transmission(s), the receiving circuity configured to receive second information used for indicating whether the SS/PBCH transmission is muted or not, and transmitting circuitry configured to perform, based on the first bitmap information and the second information, the SS/PBCH transmission(s).

### TECHNICAL FIELD

The present embodiments relate to Integrated Access and Backhaul and backhauling for New Radio (NR) networks having Next generation NodeB capabilities and signaling. In particular, the present embodiments relate to a wireless backhaul infrastructure which provides base station coordinated synchronization signal/physical broadcasting channel (SS/PBCH) block transmissions in the system for correct measurement and other purposes.

### BACKGROUND ART

In Long-Term Evolution (LTE) and New Radio (NR), User Equipment (UE) and Base Stations (SBs) may be vying for resources from Integrated Access and Backhauls (IABs). IABs may be reconfigured to carry out load balance between UE traffic and backhaul traffic.

Some mobile networks comprise IAB-donors and IAB-nodes, where an IAB-donor provides UE's interface to core network and wireless backhauling functionality to IAB-nodes; and an IAB-node that provides IAB functionality combined with wireless self-backhauling capabilities. IAB-nodes may need to periodically perform inter-IAB-node discovery to detect new IAB-nodes in their vicinity based on cell-specific reference signals (e.g., Single-Sideband SSB). The cell-specific reference signals may be broadcasted on a Physical Broadcast Channel (PBCH) where packets may be carried or broadcasted on the Master Information Block (MIB) section.

Demand of wireless traffic has increased significantly and improvements in physical layer alone cannot meet this demand. Considerations have been given for IAB backhaul design. In particular, the possibility that base stations may need to connect with those who are not nearest neighbors out of load management. However, because of higher antenna gain of receive/transmit antennas for base stations, this may not be feasible.

### SUMMARY OF INVENTION

In one example, a method of Base Station Coordinated Synchronization Block Transmissions in Integrated Access and Backhaul Network, the method comprising: transmitting, by a first base station, signals to a set of network equipment on a mobile network, wherein the signals comprise a synchronization signal/physical broadcasting channel (SS/PBCH) block; receiving, by a second base station, a first SS/PBCH block; wherein the SS/PBCH block is received via at least one of: Primary Synchronization Signals (PSSs) and Secondary Synchronization Signals (SSSs); connecting, by the second base station, to the first base station for backhaul traffic transmission, wherein the first base station comprises a cell identification (ID) and the second base station comprises a cell identification (ID), and the first base station cell ID is the same as the second base station cell ID; coordinating, by the first base station and the second base station, transmission of SS/PBCH blocks, wherein the coordinating of the SS/PBCH block transmission is for a User Equipment (UE) to establish a connection; transmitting, to the UE, one or more SS/PBCH blocks, wherein each SS/PBCH block is transmitted by and received from a different beam transmitted by the first base station and the second base station; determining, by the UE, measurement of each received beam of a set of beams received to identify which base station to request a connection to, wherein the determining is based on a quality of measurement for a particular beam; distinguishing, by the UE, the first base station from the second base station based on a set of parameters received on the broadcast channel payload and wherein the parameters are transmitted for broadcast on the SS/PBCH block.

In one example, a first base station device comprising addressable memory and processor, the processor configured to: transmit signals to a set of network equipment on a mobile network, wherein the signals comprise a synchronization signal/physical broadcasting channel (SS/PBCH) block via at least one of: Primary Synchronization Signals (PSSs) and Secondary Synchronization Signals (SSSs); establish a connection with a second base station for backhaul traffic transmission, wherein the first base station comprises a cell identification (ID) and the second base station comprises a cell identification (ID), and the first base station cell ID is the same as the second base station cell ID; coordinating transmission of SS/PBCH blocks, wherein the coordinating of the SS/PBCH block transmission is for a User Equipment (UE) to establish a connection; transmit, to the UE, one or more SS/PBCH blocks, wherein each SS/PBCH block is transmitted by and received from a different beam transmitted by the first base station and the second base station; thereby allowing the UE to determine measurement of each received beam of a set of beams received to identify which base station to request a connection to, wherein the determining is based on a quality of measurement for a particular beam; distinguish itself from the second base station based on a set of parameters received on the broadcast channel payload and wherein the parameters are transmitted for broadcast on the SS/PBCH block.

### BRIEF DESCRIPTION OF DRAWINGS

The various embodiments of the present embodiments now will be discussed in detail with an emphasis on highlighting the advantageous features. These embodiments depict the novel and non-obvious aspects of the invention shown in the accompanying drawings, which are for illustrative purposes only. These drawings include the following figures, in which like numerals indicate like parts:

FIG. 1 illustrates a mobile network infrastructure using 5G signals and 5G base stations.

FIG. 2 illustrates a mobile network infrastructure where a number of UEs are connected to a set of IAB-nodes and the IAB-nodes are in communication with each other and/or an IAB-donor.

FIG. 3A illustrates an example flow of information transmit/receive and/or processing by an IAB-donor (parent) in communication with an IAB-node (child) and UE.

FIG. 3B illustrates an example flow of information transmit/receive and/or processing by an IAB-node (child) in communication with an IAB-donor (parent) and UE.

FIG. 4 illustrates an example of a radio protocol architecture for the discovery and control planes in a mobile network.

FIG. 5 illustrates an example of a set of components of a user equipment or base station.

FIG. 6 illustrates an example top level functional block diagram of a computing device embodiment.

FIG. 7A illustrates an example flow of information transmit/receive and/or processing by an IAB-node (child) in communication with an IAB-donor (parent) and UE.

FIG. 7B illustrates an example flow of information transmit/receive and/or processing by an IAB-node (child) in communication with an IAB-donor (parent) and UE.

### DESCRIPTION OF EMBODIMENTS

The various embodiments of the present Base Station Coordinated Synchronization Block Transmissions in Integrated Access and Backhaul Network have several features, no single one of which is solely responsible for their desirable attributes. Without limiting the scope of the present embodiments as expressed by the claims that follow, their more prominent features now will be discussed briefly. After considering this discussion, and particularly after reading the section entitled “Detailed Description,” one will understand how the features of the present embodiments provide the advantages described herein.

Embodiments disclosed provide coordinated Integrated Access and Backhaul (IAB) nodes, for example, IAB-parent nodes and IAB-child nodes (also referred to as IAB-donor and IAB-node, respectively) for a scenario with the IAB-donor and IAB-node sharing the same cell ID. That is, via Synchronization Signal/Physical Broadcasting Channel (SS/PBCH) blocks UEs accessing a NR radio access network and IAB base stations (eNB/gNB) using resources for backhauling traffic, may coordinate access and identify which node they have permission to connect to and which they do not have permission. In some embodiments, discovery information may be used as a bar signal to help control the resource access, therefore, it is important for the IAB-donor to determine whether a node requesting to connect to is a UE connection request or an IAB-node connection request.

The various embodiments of the present Base Station Coordinated Synchronization

Block Transmissions in Integrated Access and Backhaul Network now will be discussed in detail with an emphasis on highlighting the advantageous features. Additionally, the following detailed description describes the present embodiments with reference to the drawings.

A mobile network used in wireless networks, may be where the source and destination are interconnected by way of a plurality of nodes. In such a network the source and destination do not communicate with each other directly due to the distance between the source and destination being greater than the transmission range of the nodes. Accordingly, intermediate node(s) may be used to relay information signals. In a hierarchical telecommunications network, the backhaul portion of the network may comprise the intermediate links between the core network and the small subnetworks of the entire hierarchical network. Integrated Access and Backhaul (IAB) Next generation NodeB use 5G New Radio communications and typically provide more coverage per base station. That is, a 5G NR user equipment (UE) and 5G NR based station (gNodeB or gNB) may be used for transmitting and receiving NR User Plane data traffic and NR Control Plane data. Both, the UE and gNB may include addressable memory in electronic communication with a processor. In one embodiment, instructions may be stored in the memory and are executable to process received packets and/or transmit packets according to different protocols, for example, Medium Access Control (MAC) Protocol and/or Received Radio Link Control (RLC) Protocol.

In some aspects of the Base Station Coordinated Synchronization Block Transmissions in Integrated Access and Backhaul Network embodiments, a sharing of spectrum for cellular access by the User Equipment (UE) terminals and Base Transceiver Stations (BTSs or BSs) is disclosed. In one embodiment, this may be done by the physical layer perspective, e.g., Physical Random Access Channel (PRACH). Some systems provide a PRACH for use by UEs to request an uplink allocation from the Base Station. The request may comprise a Cell ID (CID) that is a generally unique number used to identify each BTS, allowing for the IAB to determine whether the request is from a UE or BTS.

In a mobile network, an IAB child node may use the same initial access procedure (discovery) as an access UE to establish a connection with an IAB node/donor or parent-thereby attach to the network. In one embodiment, the donor or parent node and relay node may share the same Cell ID, whereas in other embodiments, the donor node and relay node may maintain separate Cell IDs. Some embodiments may use Single Sideband modulation (SSB), for example, Channel state information reference signal (CSI-RS), for configuration among the IAB nodes. CSI-RS may provide a method of wireless communication via transmitting channel state information reference signal (CSI-RS) configuration information to user equipment (UE). The CSI-RS configuration information transmitted to the UE may provide access information for the IAB.

Embodiments of the present system disclose methods and devices for achieving access for IAB so that both cellular access and backhaul access may be accomplished independently. In one embodiment, if access may not be achieved independently, the system may allow an operator to privilege backhaul traffic and access to the time frequency resources over the cellular access. In some examples of the Base Station Coordinated Synchronization Block Transmissions in Integrated Access and Backhaul Network embodiments, the following consideration may be made in order to achieve the independent access or privileged traffic:
Use of transmit power and weighted summation of Primary Synchronization Signals (PSSs) and Secondary Synchronization Signals (SSSs) as a means of distinguishing between an IAB cell and a UE access cell;
Use of Cell ID mapping to indicate the existence of PRACH resources available for IAB;
Transmission of available PRACH resources in a broadcast channel;
A signal indicating that UEs need not attempt connection in a broadcast channel—thereby signaling that a gNB cell is corresponding to a backhaul cell, e.g., only IAB is permitted to attached and connect;
Means for coordination of IAB cells SSB transmissions.

In one embodiment, the system may provide a method for controlling access to the IAB node of the mobile network by a User Equipment (UE), where only other IAB nodes are permitted to attach and connect. In this embodiment, a signal indicating that UEs need not attempt connection may be transmitted by using discovery information from the IAB on a broadcast channel (carried by Physical Broadcast Channel (PBCH)), where the broadcast channel is carrying information bit(s). That is, the UE may detect a synchronization signal while deciding which cell to camp on and the IAB may be signaling that an IAB node (or gNB cell) is corresponding to a backhaul cell and bar the UE from camping on the IAB node all together. Since the IAB node itself may be configured to listen for (or attempt to receive) synchronization signals from UEs and other IAB nodes (parent IABs), via PSS or SSS on the SSB, the IAB node may obtain the cell identity (Cell ID) and determine a set of parameters associated with the device sending the signal. That is, in some embodiments, the synchronization signal may comprise discovery information thereby the IAB may derive the Cell ID and location of the broadcast channel for the device sending the signal, to then determine the set of parameters. In the scenario where the IAB node and UE share the same bandwidth, the parent gNB may broadcast synchronization signal and broadcast channel to UE and the IAB child nodes.

In one embodiment, the IAB child node may determine a Cell ID via the received synchronization signals which have been mapped to the Cell ID, and use the determined set of parameters transmitted and received, for broadcast attempt, to get into connected mode with the IAB parent node or gNB. Thereby, the discovery information in the SSB may differentiate which terminal device is authorized to connect to the network and therefore use the signal to bar UEs from connecting to the IAB. In this scenario, the IAB may transmit a barring signal to the UE on the broadcast control channel within the network cell and set up, based on the barring signal, an access control to the service with regard to the UE by deciding whether a specific access request of the UE to the service is accepted or rejected.

In an embodiment where Cell IDs are different, the discovery information may be used to bar UE access for load balancing reasons. That is, via the broadcast channel—when Cell IDs are different-the signal may be used to bar UE access by determining whether it is a UE or IAB sending the signal through the lookup of parameters. In an embodiment where the IAB node and UE share the same bandwidth, the parent gNB broadcasts synchronization signal on the broadcast channel to the UEs, so the timing of the transmission to IAB node and UE is aligned. The Cell IDs may be received via a Random-Access Channel (RACH) which may be a shared channel used by wireless terminals to access the mobile network where RACH is on the transport-layer channel and the corresponding physical-layer channel is PRACH.

According to the aspects of the embodiments, the parent gNB may transmit discovery information via the PBCH to IAB nodes and UEs, where the IAB nodes and UEs read the information. If the parent gNB indicates in the discovery information that the UE is barred from the cell due to load reason, then the UE has to find another cell to camp. Additionally, the IAB node can select that cell to connect to or camp on, if the discovery information from PBCH allow it to do so. That is, there is a selection process allowing the discovery information on the synchronization signal to indicate whether a device may camp or may not camp at the cell (IAB parent node or parent GNB). If the parent gNB doesn't indicate the UE is barred from the cell in the discovery information, then the UE may continue to camp on the cell; where the PRACH procedures may then start to be implement in this scenario.

The Physical Random Access Channel (PRACH) is used by an uplink user to initiate contact with a base station. The base station broadcasts some basic cell information, including where random-access requests can be transmitted. A UE then makes a PRACH transmission asking for, for example, PUSCH allocations, and the base station uses the downlink control channel (PDCCH) to reply where the UE can transmit PUSCH. In the scenario where the UE camps on the cell, if the UE wants any connection with the network, it will start PRACH procedures, thereafter, if the UE obtains PRACH resources successfully for PRACH preamble transmission, then the UE may have further communication with the network, until it successfully completes PRACH procedures and set up connection with the network. Otherwise, the UE has to reselect PRACH resources to restart the PRACH procedures. In this embodiment, the system may prioritize the opportunity of backhaul to obtain PRACH resources successfully (if there are no conflicts with other IAB backhaul node and UEs).

An alternative embodiment consists of having a cell in which there is a single Cell ID for both cellular access and backhaul. In this embodiment the set of PRACH resources, specifically, the PRACH sequences, are partitioned into two sets, which may be configurable or be preconfigured and/or predefined by the network. One set is used for PRACH access for UEs, while the remainder of the set may be used for backhaul access for gNBs.

For example:

Assuming the total number of PRACH preamble sequences is X, e.g., 64, the parameter numberOfRA-PreamblesGroupBackIabhaul, or numberOfRA-PreamblesGroupIabUE, can be configured, which defines the number of Random Access Preambles in Random Access Preamble group dedicated for IAB Backhaul use, or IAB UE use respectively.

Either numberOfRA-PreamblesGroupIabBackhaul, or numberOfRA-PreamblesGroupIabUE, or both of them can be configured by the network. For convenience, we call them numberOfRA-PreamblesGroupIabX

numberOfRA-PreamblesGroupIabX can be for each synchronization signal/PBCH block (SSB), or for each cell, or for each IAB gNB/UE; if it is for each IAB gNB, which means all cells belonging to/associated with the IAB gNB share the preamble sequences defined by numberOfRA-PreamblesGroupIabX

If numberOfRA-PreamblesGroupA is configured, which defines the number of Random Access Preambles in Random Access Preamble group A for each SSB, if Random Access Preambles group B is configured, and if numberOfRA-Pream-blesGroupIabX is(are) for each SSB and configured, then there are the following alternative design:

Alt 1> numberOfRA-PreamblesGroupIabX has nothing related to numberOfRA-PreamblesGroupA and numberOfRA-PreamblesGroupB, which means these two types of parameters are independently configured. RA-PreamblesGroupIabX may, or may not, have overlap with RA-PreamblesGroupA/RA-PreamblesGroupB

Alt 2> numberOfRA-PreamblesGroupIabX is a subset of numberOfRA-PreamblesGroupA, or numberOfRA-PreamblesGroupB. For example, assuming totally there are 64 RA preamble sequences, and there are 48 RA preamble sequences (e.g., RA preamble sequence index from 0 to 47, or from 1 to 48) allocated to PreamblesGroupA, and 18 sequences are allocated to PreamblesGroupB. numberOfRA-PreamblesGroupIabBackhaul can be a value not greater than numberOfRA-PreamblesGroupA, e.g., 40, which allows IAB backhaul to use preamble sequence index from 0 to 39, or from 1 to 40. As PreamblesGroupIabUE should be subset as well, e.g. when numberOfRA-PreamblesGroupIabUE is 10, IAB UE is allowed to use preamble sequence index from 40 to 49, or 41 to 50.

Alt 3> RA-PreamblesGroupIabX allows IAB gNB/UE to use preamble sequences with index mutual exclusive from PreamblesGroupA and PreamblesGroupB. For example, RA-PreamblesGroupIabX allows IAB gNB/UE to use preamble sequences with index 41 to 64 if the first 40 indexes are configured by the network to be used by PreamblesGroupA and PreamblesGroupB.

In an embodiment where same Cell ID action (as opposed to different Cell ID action) is used for UE access and backhaul access, given that the same time frequency resources are used for UE access and backhaul access, that at least because of the expanded range requirements, the number of available cyclic shifts available for RACH access may decline significantly.

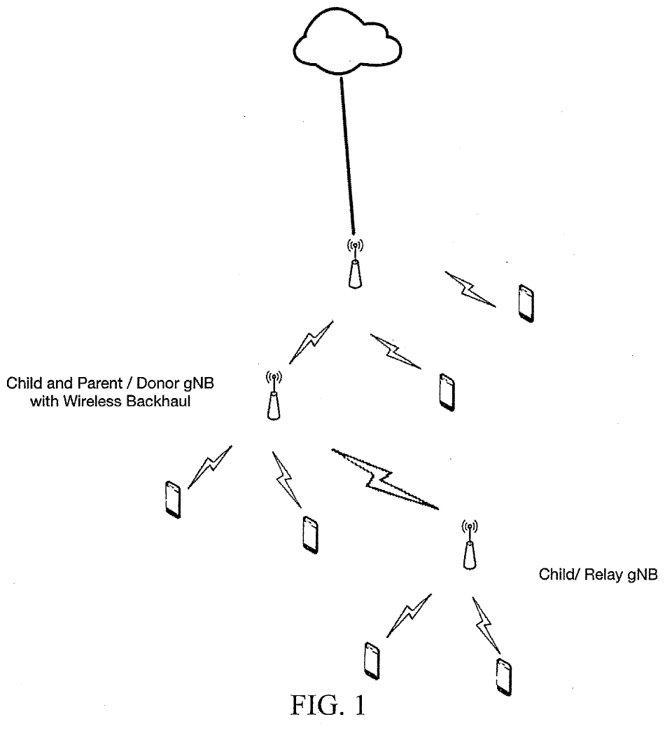

With reference to FIG. 1, the present embodiments include a mobile network infrastructure using 5G signals and 5G base stations (or cell stations). As depicted, an integrated access provides gNBs with coordination between gNBs in response to changing cellular and backhaul traffic states, therefore load balancing may be achieved by controlling access (e.g., access class baring) to network devices (e.g., UEs). Allowing the coordination of resources in response thereof may be via the Integrated Access and Backhaul topology comprising the transmission of discovery information between IAB-donors and IAB-nodes and IAB-donors and UEs, exchanged as part of the synchronization signals (if the network is not synchronized, SSB may be used for discovery instead). Accordingly, modifying the coordination to allow limiting of resources that are requested by the UEs in the network due to backhaul traffic conditions may be implemented based on barring an access class associated with the UE, prioritizing use of resources based on needs of the wireless communication system and load management, and/or partitioning resources provided by the first base station based on the class of network equipment (terminal device).

With further reference to FIG. 1, a number of UEs are depicted as in communication with gNBs where a Child gNB is in communication with a Parent gNB with wireless backhaul. For example, a Parent gNB may transmit discovery signals to Child gNB, thereby extending the backhaul resources to allow for the transmission of backhaul traffic within the network and between parent and child for integrated access. The embodiments of the system provide for capabilities needed to use the broadcast channel for carrying information bit(s) (on the physical channels) and provide IAB discovery information carried on the PBCH to bar or not bar the UE from camping-may be done via access class baring, where access classes may be representable via partitioning RACH. In such embodiments, the discovery information may be used as an access class baring flag.

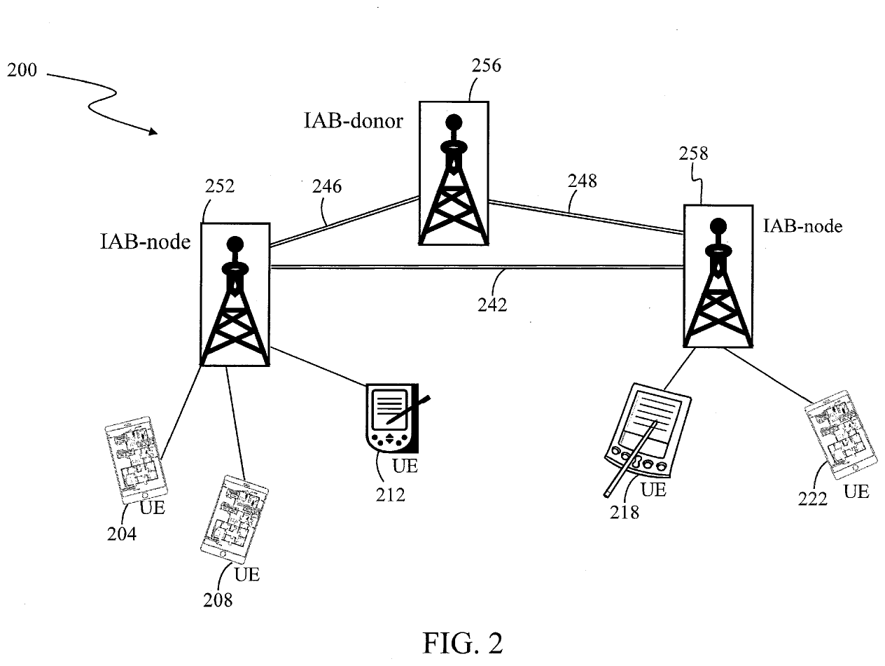

FIG. 2 depicts another example of a mobile network infrastructure where a number of UEs are connected to a set of IAB-nodes and the IAB-nodes are in communication with each other and/or an IAB-donor using the different aspects of the present embodiments. That is, the IAB-nodes may send out discovery information to other devices on the network (i.e., the Cell ID and resource configuration of the transmitting nodes are sent to the receiving node). The UEs may also be receiving discovery information and if not barred, then requesting connections and to use resources by transmitting connection requests to the IAB-nodes and/or IAB-donors. In one embodiment, an IAB-donor may limit or bar any requests from UEs for connection due to them being already connected to other IAB-nodes and committed resources to the backhaul traffic. In another embodiment, the IAB-donor may accept the UE's connection request but prioritize the IAB-node backhaul traffic over any connections used by the UE's. In yet another embodiment, the IAB-donor may partition resources provided by the IAB-donor between IAB-nodes and UEs, where the partitioning may be based on the load balancing needs of the network.

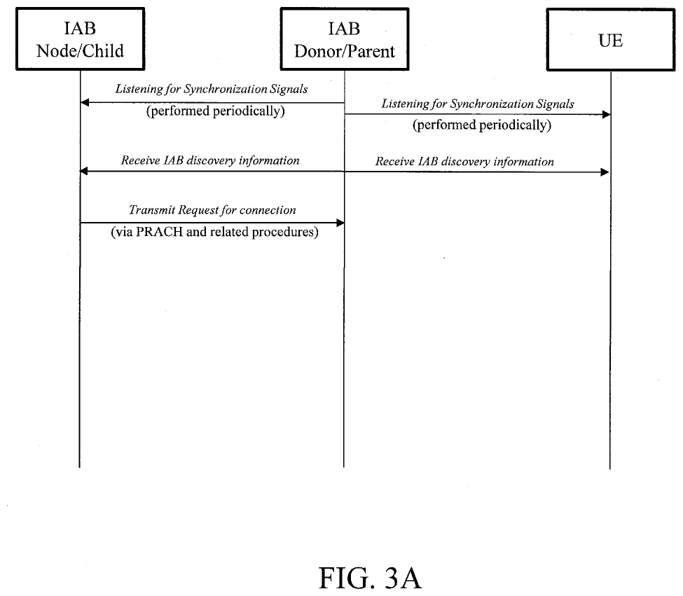

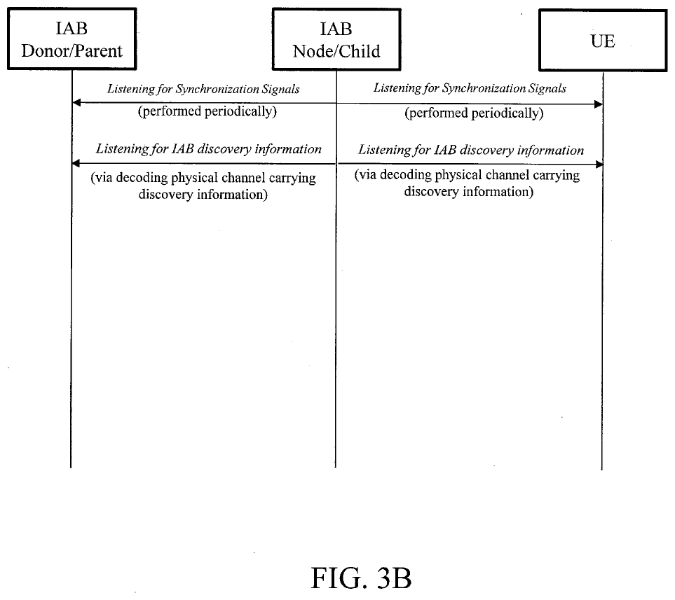

FIG. 3A is a diagram of an example flow of information transmit/receive and/or processing by a IAB-donor (parent), IAB-node (child), and UE according to aspects of the present embodiments. The communication method of FIG. 3 depicts an IAB-donor determining access to resources by transmitting synchronization signals to other devices looking to connect. In this embodiment, the IAB-node and UE may be listening for such synchronization signals on the broadcast channel. In one embodiment, IAB-nodes periodically perform inter-IAB-node discovery to detect new IAB-nodes and/or device discovery to detect new UEs. The IAB-node and UE may receive IAB discovery signals in the scenario where IAB-node and UE share the same bandwidth. The IAB-donor determines whether any resources may be allocated to cellular traffic and whether there are IAB/gNB connections using resources for backhaul traffic. In one embodiment, IAB-donor may be specific nodes as NR cells which only connect with IAB-node children, where the synchronization information (mapped to a Cell ID) itself may not be sufficient to determine whether the IAB is a IAB-donor specific for IAB-node children or allowing attachment of UEs. Accordingly, the IAB discovery signal (e.g., waveform and/or specific sequence of bits on a broadcast channel system information block) may be used to signal that the IAB is an IAB-donor parent node and IAB-node children should attempt to connect with the IAB-donor. The IAB-node may transmit a request for connection via PRACH and related procedures, where the PRACH may be transmitted via cell-specific signals (e.g., SSB) and are to be used for all receiving IAB-nodes. The UE may receive via synchronization signals the Cell ID of the parent node and if the IAB discovery information comprises a UE baring signal and/or flag, then only IAB-node (child) may initiate a transmission request for connection.

FIG. 3B depicts a diagram of an example flow of information transmit/receive and/or processing by a IAB-donor (parent), IAB-node (child), and UE according to aspects of the present embodiments. FIG. 3B depicts the IAB-node (child) as determining access to resources (versus FIG. 3A showing the determination from the IAB-donor (parent) perspective). The nodes and/or UEs listening for synchronization signals-performed periodically-may then request connection and may in some embodiments listen for IAB discovery information which may include parameters via broadcast channel where the parameters may be used to obtain the Cell ID and identify the device. In some embodiments, this may be via decoding physical channel carrying discovery information by both the IAB-node and UE. If the UE is not barred from connection, a PRACH procedure may be performed. If the connection mode is for an IAB-node, the IAB-node may prioritize use of resources and allow the connection to be made by the IAB-donor-via sending a signal to indicate that the cell is an IAB cell and inform IAB gNBs that it is available for backhaul transmission. If the connection mode is for a UE, the IAB-node may bar the access class of the UE through the discovery information that indicate UEs need not attempt connection with an IAB cell. In some embodiments, after some period of time has lapsed, the IAB-node may reconfigure itself periodically based on changing load balance management. If at the time of reconfiguration, not all resources are being used by a connection of another IAB cell for backhaul transmission, the IAB-node may accept connection from the UE but partition the resources based on changing load balance management. The IAB-node (child) may monitor the resources, and based on the needs of the network and device, transmit barring signaling through the discovery information to the UE.

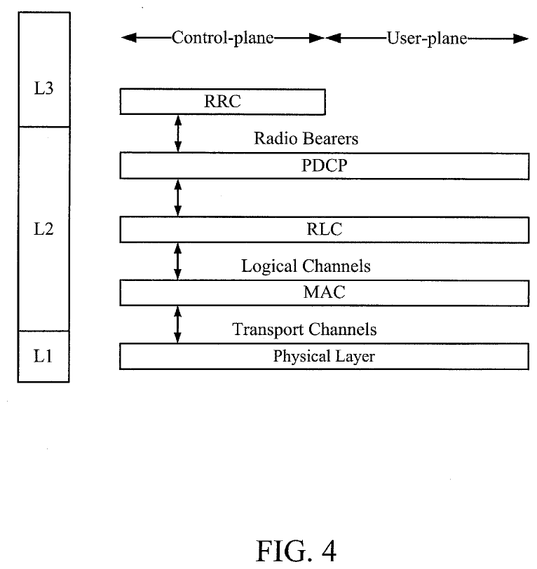

FIG. 4 is a diagram illustrating an example of a radio protocol architecture for the discovery and control planes in a mobile communications network. The radio protocol architecture for the UE and the gNodeB may be shown with three layers: Layer 1, Layer 2, and Layer 3. Layer 1 (L1 layer) is the lowest layer and implements various physical layer signal processing functions. Layer 2 (L2 layer) is above the physical layer and responsible for the link between the UE and gNodeB over the physical layer. In the user plane, the L2 layer includes a media access control (MAC) sublayer, a radio link control (RLC) sublayer, and a packet data convergence protocol (PDCP) sublayer, which are terminated at the gNodeB on the network side. Although not shown, the UE may have several upper layers above the L2 layer including a network layer (e.g., IP layer) that is terminated at the PDN gateway on the network side, and an application layer that is terminated at the other end of the connection (e.g., far end UE, server, etc.). The control plane also includes a radio resource control (RRC) sublayer in Layer 3 (L3 layer). The RRC sublayer is responsible for obtaining radio resources (i.e., radio bearers) and for configuring the lower layers using RRC signaling between the gNodeB and the UE.

In one embodiment, a Cell ID mapping to indicate the existence of PRACH resources available for IAB may be used. This transmission of available PRACH resources on the physical layer may be done in a broadcast channel and processed by the RRC sublayer of FIG. 4. In some embodiments, the differential between child/parent (node/donor) connection gNB may be determined and the gNB may represent different access classes (representable via RACH resources). Using the RACH to differential the access classes may allow a GNB to permanently bar a UE from access to the IAB-node until such time that the network reconfigures itself and determines there are resources available to be given.

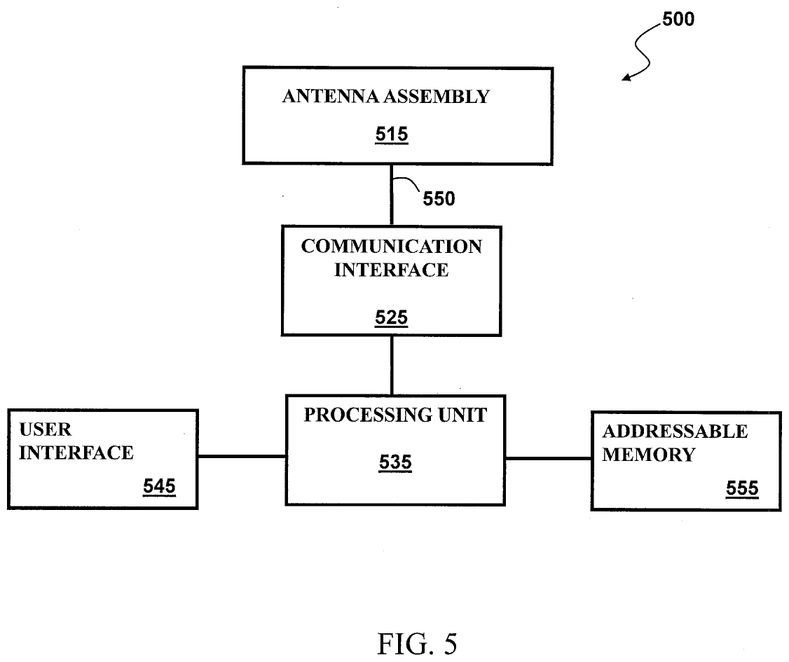

FIG. 5 illustrates an embodiment of a user equipment and/or base station comprising components of a device 500 according to the present embodiments. The device 500 illustrated may comprise an antenna assembly 515, a communication interface 525, a processing unit 535, a user interface 545, and an addressable memory 555. Where the antenna assembly 515 may be in direct physical communication 550 with the communication interface 525. The addressable memory 555 may include a random access memory (RAM) or another type of dynamic storage device, a read only memory (ROM) or another type of static storage device, a removable memory card, and/or another type of memory to store data and instructions that may be used by the processing unit 535. The user interface 545 may provide a user the ability to input information to the device 500 and/or receive output information from the device 500.

The communication interface 525 may include a transceiver that enables mobile communication device to communicate with other devices and/or systems via wireless communications (e.g., radio frequency, infrared, and/or visual optics, etc.), wired communications (e.g., conductive wire, twisted pair cable, coaxial cable, transmission line, fiber optic cable, and/or waveguide, etc.), or a combination of wireless and wired communications. The communication interface 525 may include a transmitter that converts baseband signals to radio frequency (RF) signals and/or a receiver that converts RF signals to baseband signals. The communication interface 525 may also be coupled (not shown) to antenna assembly 515 for transmitting and receiving RF signals. Additionally, the antenna assembly 515 may include one or more antennas to transmit and/or receive RF signals. The antenna assembly 515 may, for example, receive RF signals from the communication interface and transmit the signals and provide them to the communication interface.

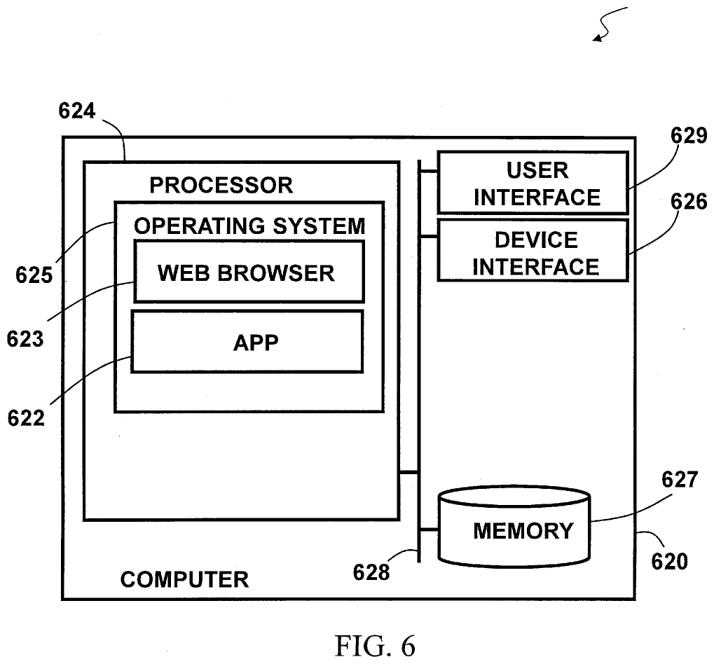

FIG. 6 illustrates an example of a top level functional block diagram of a computing device embodiment 600. The example operating environment is shown as a computing device 620 comprising a processor 624, such as a central processing unit (CPU), addressable memory 627, an external device interface 626, e.g., an optional universal serial bus port and related processing, and/or an Ethernet port and related processing, and an optional user interface 629, e.g., an array of status lights and one or more toggle switches, and/or a display, and/or a keyboard and/or a pointer-mouse system and/or a touch screen. Optionally, the addressable memory may, for example, be: flash memory, eprom, and/or a disk drive or other hard drive. These elements may be in communication with one another via a data bus 628. Via an operating system 625 such as one supporting a web browser 623 and applications 622, the processor 624 may be configured to execute steps of a process establishing a communication channel according to the exemplary embodiments described above.

As in the previous sections, in the following text, for simplicity of description, the term “IAB-donor” is used to represent either a “parent IAB-node” regarding an IAB-node, or a practical “IAB-donor” which is responsible for the physical connection with the core network.

In one embodiment, an IAB-node may follow the same initial access procedure as a UE, including cell search, system information acquisition, and random access, in order to initially set up a connection to a parent IAB-node or an IAB-donor. That is, when an IAB base station (eNB/gNB) needs to establish a backhaul connection to, or camp on, a parent IAB-node or an IAB-donor, the IAB-node may perform the same procedure and steps as a UE, and the IAB-node may be treated as a UE, by the parent IAB-node or the IAB-donor.

When an IAB-node camps on an IAB-donor, the IAB-node obtains the physical cell identifier (PCID) of the IAB-donor, through detecting the primary synchronization signal (PSS) and secondary synchronization signal (SSS) of the IAB-donor.

As the IAB-node is a base station, it also transmits its own PSS and SSS, indicating information relating to its PCID to all the UEs in its own coverage.

Therefore, scenarios with associated procedures may be designed for the following:

Scenario where IAB-donor and IAB-node share the same cell ID:

In NR systems, as described by 3GPP specification TS 38.213, a UE assumes that reception occasions of a physical broadcast channel (PBCH), PSS and SSS, are in consecutive symbols, and form a SS/PBCH block. The Synchronization Signal (SS) block and Physical Broadcast Channel (PBCH) block are packed as a single block and are transmitted together. The Synchronization Signal block may comprise: Primary Synchronization Signal (PSS) and Secondary Synchronization Signal (SSS), and the PBCH block may comprise PBCH demodulation reference signal (DMRS or DM-RS) and PBCH Data.

The candidate SS/PBCH blocks in a half frame are indexed in an ascending order in time from 0 to L-1. A UE determines the 2 least significant bit (LSB) bits, for L=4, or the 3 LSB bits, for L>4, of a SS/PBCH block index per half frame from a one-to-one mapping with an index of the DM-RS sequence transmitted in the PBCH. For L=64, the UE determines the 3 most significant bit (MSB) bits of the SS/PBCH block index per half frame by PBCH payload bits. In some embodiments, the SS/PBCH block transmissions may be associated with certain beam(s)' transmissions in each cell, which may be a one to one, one to multiple, or multiple to one association. For example, if a gNB has L=4 antenna beams, assuming all 4 beams are actively used for transmissions and each beam has one particular SS/PBCH block transmission, then in a period of half frame, there may exist a relationship provided as follows: the first beam of the gNB transmits SS/PBCH block with SS/PBCH block index=0 (00 in binary); the second beam of the gNB transmits SS/PBCH block with SS/PBCH block index=1 (01 in binary); the third beam of the gNB transmits SS/PBCH block with SS/PBCH block index=2 (10 in binary); and the forth beam of the gNB transmits SS/PBCH block with SS/PBCH block index=3 (11 in binary).

In an embodiment where the IAB-donor and IAB-node share the same cell ID, the IAB-node may become transmission and reception point(s) (TRP(s)), or beam(s), of the IAB-donor. Both IAB-donor and IAB-node should transmit the same PSS and SSS in their SS/PBCH blocks. However, when the UE receives the SS/PBCH block from IAB-donor and IAB-node with the same SS/PBCH block index, it may cause issues with identification of the node by the requester. For example, SS/PBCH blocks (both with index=0 from IAB-donor and IAB-node) may not necessarily be transmitted from the same antenna beam; it is more likely that the SS/PBCH blocks are not from the same antenna beam, if there is no coordination between the IAB-donor and the IAB-node. When the UE performs measurement for each beam, the UE might treat the measurement from the beams with the same SS/PBCH block index as coming from the same beam or IAB-donor/IAB-node, hence the wrong quality measurement may be calculated for that beam; consequently, wrong operations might occur based on the measurement.

Alternate embodiments are disclosed which address the issues of coordinated SS/PBCH block transmission thereby providing correct measurements. Any single or any combination of the proposed alternative designs may be used by the IAB-donor, and/or IAB-node, and/or UE to handle and manage the miscalculation of beams having been transmitted from the same node.

In one embodiment (Alt 1-A>), an indicator or flag may be carried in the SS/PBCH block to indicate whether the signal is received from the IAB-donor or from the IAB-node.

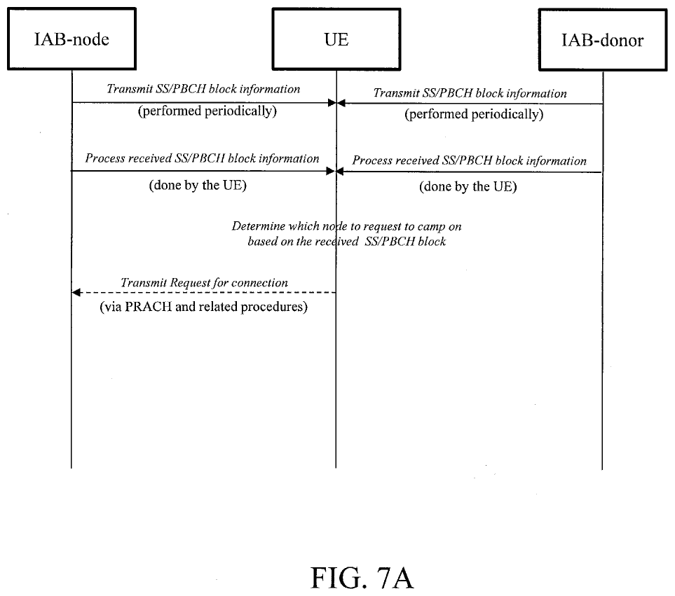

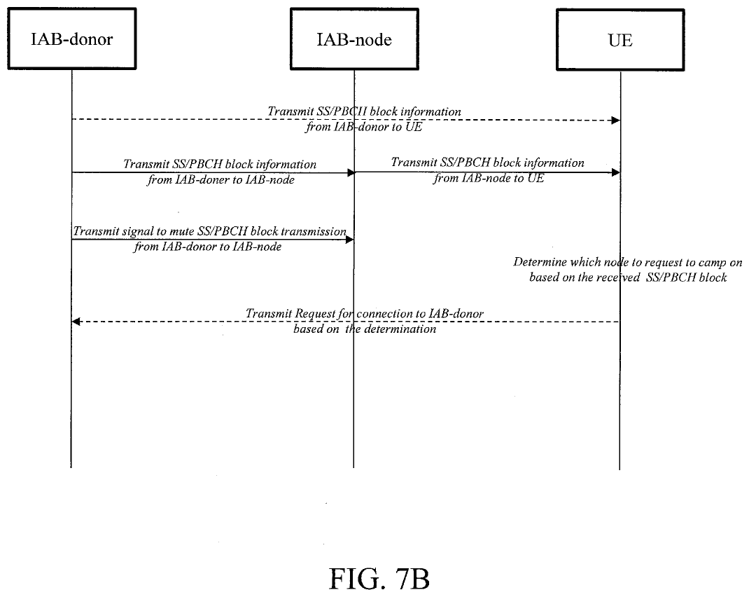

FIG. 7A depicts a diagram of an example flow of information transmit/receive and/or processing by a IAB-donor (parent), IAB-node (child), and UE according to aspects of the present embodiments. FIG. 7A depicts the UE as listening for synchronization signal/PBCH block information from the IAB-node and IAB-donor and processing the received SS/PBCH block information to determine whether the UE may camp on the node and have access to resources. The UE may parse or process the SS/PBCH block and look, for example, for a flag or index, to determine whether the synchronization signal is coming from an IAB-node or an IAB-donor. Since both the IAB-node and IAB-donor have the same Cell ID, the SS/PBCH block carrying the flag or index (as further discussed below) may in one example, indicate to the UE which node-and subsequently which beam(s)-may be transmitting the synchronization signal and optionally whether or not the UE may transmit a request for connection to camp on that cell.

In an embodiment of an SSB transmission, in addition to using SSB for camping, the SSB may be used, for example, for SS within the SSB in order for the UE to synchronize, the PBCH in the SSB may be used for broadcasting important system information. Additionally, the SSS and DMRS in the SSB may be used for measurement, and the purpose of measurement therefore, as illustrated in FIG. 7A, the UE's camping procedure is just one example of using the coordinated SSB transmission, but an optional step and used here for illustration purposes.

In one example (1-A1), 1 bit information may be carried in the PBCH of the SS/PBCH block, indicating or signaling that the SS/PBCH is transmitted from an IAB-donor, or from an IAB-node, e.g., “0” indicating IAB-donor, while “1” indicating IAB-node; or alternatively “1” indicating IAB-donor, while “0” indicating IAB-node.

In another example (1-A2), multiple-bit information may be carried in the PBCH of the SS/PBCH block. The difference from the example 1-A1 above is that multiple bits may be used to give the index of the IAB-donor and IAB-node. In this example, the network may allow/configure up to M base stations to camp on 1 base station, e.g., up to M IAB-nodes may camp on the same IAB-donor. Therefore ceil(log2M) bits, or ceil(log2(M+1)) bits (if counting in the IAB-donor) are required to indicate to the UE which SS/PBCH block is transmitted from which base station, e.g., M=4 and IAB-donor is counted in the index information, then 3 bits of information are required to deliver the index, so for example: “000” may indicate IAB-donor, “001”, “010”, “011”, “100” may indicate different IAB-nodes; unused values may be reserved for other purpose.

In another example (1-A3), if hop number information is important in terms of, e.g., timing consideration, multiple-bit information may be carried in the PBCH of the SS/PBCH block. The difference from the example 1-A2 is that multiple bits are used to give the hop number information of base stations from the IAB-donor. If IAB-donor means 0 hop from itself, and up to M hops are allowed/configured by the network, then ceil(log2(M+1)) bits are required to indicate to the UE which SS/PBCH block is transmitted from which base station with how many hops from the IAB-donor, e.g., M =4, then 3 bits' information are required to deliver the index, so for example: “000” may indicate IAB-donor itself, “001”, “010”, “011”, “100” may indicate IAB-nodes with 1, 2, 3 and 4 hops from the IAB-donor; unused values may be reserved for other purpose.

The three examples (1-A1, 1-A2, and 1-A3) all use PBCH payload bit(s) in the SS/PBCH to carry the information. In some embodiments, the above information may also be carried in other ways or methods. For example, similar to the delivery of SS/PBCH block index information (as disclosed above in relation to the candidate SS/PBCH blocks being transmitted and indexed in half frame), some MSB or LSB bit(s) of the information may be carried by the PBCH payload bit(s), and the remaining bit(s) may be carried in another way, e.g., from a one-to-one mapping with an index of the DM-RS sequence transmitted in the PBCH.

In another embodiment (Alt 1-B>), the IAB-donor may send and/or transmit one or more signals to one, some, or all IAB-node(s) camping on its cell, to mute one, some, or all SS/PBCH block transmissions. That is, the signal from the IAB-donor may indicate that a set of one or more IAB-nodes are barred from transmitting any SS/PBCH blocks.

FIG. 7B depicts a diagram of an example flow of information transmit/receive and/or processing by a IAB-donor (parent), IAB-node (child), and UE according to aspects of the present embodiments. FIG. 7B depicts the IAB-donor and IAB-node as transmitting synchronization signal/PBCH block information to potential UEs to allow them to camp on the IAB-donor or IAB-node. As depicted in the example, sync signals are sent out from the IAB-donor to the UE, IAB-node to the UE, and IAB-donor to the IAB-node. In this embodiment, the IAB-donor has determined that the previously camped IAB-node should no longer be sending out sync signals and thereby transmits a signal to the IAB-node to mute the SS/PBCH block transmissions by the IAB-node-effectively barring any other nodes from camping on the IAB-node. In one embodiment, the IAB-donor may continue to transmit synchronization signals to allow for the UE in this example, to camp on the IAB-donor and prevent any miscalculations of beams or signal strengths handling by the UE given that both the IAB-donor and IAB-node have the same Cell ID. As explained further below, the IAB-donor may send this signal to mute transmission of SS/PBCH block by IAB-node, to a subset of a set of IAB-nodes that are camped on the IAB-donor.

Additionally, the mute signal may be sent to a subset of IAB-nodes via a grouping mechanism where one or more IAB-nodes may be part of a set of groups, thereby having multiple groups each having one or more IAB-nodes as members of the group. According to this embodiment, the IAB-donor may mute IAB-nodes based on a Group ID which if matched in signaling, then those IAB-nodes would not transmit any SS/PBCH blocks. One embodiment may implement a Group ID that may be any newly defined ID or existing ID, such as SS/PBCH block index; the Group ID may then have a one to one, one to many, or many to one mapping relationship with existing ID.

In one example (1-B1), one bit information (“0” or “1”), which may be a ON/OFF key of SS/PBCH block transmissions may be sent to the IAB-node(s) camping on the IAB-donor cell, in either broadcasting signals or signaling (e.g., broadcasting system information), dedicated RRC signaling, or MAC control element (CE). When the IAB-node receives the ON/OFF information in the signaling, the IAB-node may then unmute or mute all SS/PBCH block transmission accordingly.

In another example (1-B2), no particular information may be sent or transmitted from the IAB-donor; instead, the existing actual transmitted SS/PBCH block information from the IAB-donor may be used by the IAB-node(s) to perform muting of SS/PBCH block transmissions.

Regarding the actual transmitted SS/PBCH block information, as it is not necessary that all beams of the base stations must work at the same time, the 3GPP specification TS 38.213 specifies that the base station may mute some of its beams in the following way:

“For SS/PBCH blocks providing higher layer parameter MasterInformationBlock to a UE, the UE can be configured by higher layer parameter ssb-PositionsInBurst in SystemInformationBlockType1, indexes of the SS/PBCH blocks for which the UE does not receive other signals or channels in REs that overlap with REs corresponding to the SS/PBCH blocks. The UE can also be configured per serving cell, by higher layer parameter ssb-PositionsInBurst in ServingCellConfigCommon, indexes of the SS/PBCH blocks for which the UE does not receive other signals or channels in REs that overlap with REs corresponding to the SS/PBCH blocks. A configuration by ssb-PositionsInBurst in ServingCellConfigCommon overrides a configuration by ssb-PositionsInBurst in SystemInformationBlockType1.”

According to the above spec description, either ssb-PositionsInBurst in ServingCell-ConfigCommon or ssb-PositionsInBurst in SystemInformationBlockType1 provides the information of the actual transmitted SS/PBCH block(s) out of the nominal SS/PBCH block transmissions, e.g., information element (IE) ssb-PositionsInBurst carrying the value “1 1 0 1” in one way can be interpreted as the situation that the first, second, and fourth SS/PBCH block are actually transmitted by the IAB-donor.

When the IAB-node receives the ssb-PositionsInBurst or similar information, it may perform in one, some, or all of the following ways:
(1) Mute all its own SS/PBCH block transmissions;

(2) Determine which SS/PBCH block(s) is (are) muted based on the node's own implementation;

(3) Mute one, some, or all SS/PBCH block transmissions which are overlapped with the SS/PBCH block transmissions from the IAB-donor.

If the IAB-node receives both the “ON/OFF” information (example 1-B1) and “ssb-PositionsInBurst” or similar information from the IAB-donor, the “OFF” command may supersede the other information and mute all SS/PBCH block transmission, while the “ON” command may either override the “ssb-PositionsInBurst” information and allow all SS/PBCH block transmissions, or be combined with the “ssb-PositionsInBurst” information to mute one, some, or all SS/PBCH block transmissions depending on the “ssb-PositionsInBurst” information and IAB-node's relevant behaviors described in the example 1-B2.

In yet another example (1-B3), the IAB-donor may receive “ssb-PositionsInBurst” or similar information transmitted from the IAB-node(s), determine which SS/PBCH block(s) of the IAB-node(s) are muted, then a dedicated bitmapping information similar to “ssb-PositionsInBurst” may be sent and/or transmitted to the IAB-node(s), indicating either which SS/PBCH block(s) of the IAB-node(s) are muted or which SS/PBCH block(s) of the IAB-node(s) are allowed for transmission. In some embodiment, the information may be sent and/or transmitted in either broadcasting signals or signaling (e.g., broadcasting system information), dedicated RRC signaling, or MAC control element (CE).

In aspects of the present embodiments (for example, the disclosed design of Alternative 1-B), the control of SS/PBCH block transmission muting may not necessarily target all IAB-nodes in each control periodicity, e.g., half a frame, or other time durations.

In some embodiments, such as in the examples 1-B1 or 1-B3, in each control periodicity, only X number of IAB-node(s), where X is an integer, e.g., X=1, may be allowed to transmit SS/PBCH block information, while all the remaining IAB-node(s) are muted.

For example, in the example 1-B2, the IAB-node might not only have conflicts with the IAB-donor SS/PBCH block transmissions, but also other IAB-node SS/PBCH block transmissions. In the embodiment where in each control periodicity, only 1 IAB-node is permitted to transmit, there won't be conflicts among IAB-nodes' SS/PBCH block transmissions. Such control may also be combined with the example 1-B1 or 1-B3, thus actually being controlled by the IAB-donor signaling; or controlled by some other mechanisms, for example, some timer mechanisms might be related, e.g., if one IAB-node starts to transmit SS/PBCH blocks, a timer in the MAC layer of the IAB-node is activated, and when the timer expires, the IAB-node's SS/PBCH block transmission should be muted. In an embodiment where the network carefully designs the timer duration and timer activation timing, the conflicts of SS/PBCH block transmission among IAB-node(s) may be avoided.

The abovementioned features may be applicable to 3rd Generation Partnership Project; Technical Specification Group Radio Access Network; Study on Integrated Access and Backhaul; (Release 15) for 3GPP TR 38.874 V0.3.2 (2018-06) and applicable standards.

The above description presents the best mode contemplated for carrying out the present embodiments, and of the manner and process of practicing them, in such full, clear, concise, and exact terms as to enable any person skilled in the art to which they pertain to practice these embodiments. The present embodiments are, however, susceptible to modifications and alternate constructions from those discussed above that are fully equivalent. Consequently, the present invention is not limited to the particular embodiments disclosed. On the contrary, the present invention covers all modifications and alternate constructions coming within the spirit and scope of the present disclosure. For example, the steps in the processes described herein need not be performed in the same order as they have been presented, and may be performed in any order(s). Further, steps that have been presented as being performed separately may in alternative embodiments be performed concurrently. Likewise, steps that have been presented as being performed concurrently may in alternative embodiments be performed separately.

<Cross Reference>

This Nonprovisional application claims priority under 35 U.S.C. § 119 on provisional Application No. 62/716,897 on Aug. 9, 2018, the entire contents of which are hereby incorporated by reference.

What is claimed is:

1. An Integrated Access and Backhaul (IAB) node that communicates over a radio interface, the IAB node comprising:
receiving circuity configured to receive first bitmap information used for indicating which synchronization signal and physical broadcast channel block (SS/PBCH block) is transmitted in a SS/PBCH block transmission(s),
the receiving circuity configured to receive second information used for indicating whether the SS/PBCH transmission is muted or not, and transmitting circuitry configured to perform, based on the first bitmap information and the second information, the SS/PBCH transmission(s).

2. The IAB node of claim 1, wherein
the SS/PBCH block is used for a measurement by an IAB node in a case that the SS/PBCH block is transmitted in the SS/PBCH transmission(s).

3. An Integrated Access and Backhaul (IAB) donor that communicates over a radio interface, the IAB donor comprising:
transmitting circuity configured to transmit first bitmap information used for indicating which synchronization signal and physical broadcast channel block (SS/PBCH block) is transmitted in a SS/PBCH block transmission(s),
the transmitting circuity configured to transmit second information used for indicating whether the SS/PBCH transmission is muted or not.

4. The IAB donor of claim 3, wherein
the SS/PBCH block is used for a measurement by an IAB node in a case that the SS/PBCH block is transmitted in the SS/PBCH transmission(s).

5. A method of an Integrated Access and Backhaul (IAB) node that communicates over a radio interface, the method comprising:
receiving first bitmap information used for indicating which synchronization signal and physical broadcast channel block (SS/PBCH block) is transmitted in a SS/PBCH block transmission(s),
receiving second information used for indicating whether the SS/PBCH transmission is muted or not, and
transmitting circuitry configured to perform, based on the first bitmap information and the second information, the SS/PBCH transmission(s).

The method of claim 5, wherein
the SS/PBCH block is used for a measurement by an IAB node in a case that the SS/PBCH block is transmitted in the SS/PBCH transmission(s).

7. A method of an Integrated Access and Backhaul (IAB) donor that communicates over a radio interface, the method comprising:
transmitting first bitmap information used for indicating which synchronization signal and physical broadcast channel block (SS/PBCH block) is transmitted in a SS/PBCH block transmission(s), transmitting second information used for indicating whether the SS/PBCH transmission is muted or not.

8. The method of claim 7, wherein
the SS/PBCH block is used for a measurement by an IAB node in a case that the SS/PBCH block is transmitted in the SS/PBCH transmission(s).
